(19) United States
(12) Patent Application Publication
(10) Pub. No.: US 2026/0063193 A1
(43) Pub. Date: Mar. 5, 2026

(54) Actuator

(71) Applicant: Tokyo Parts Industrial Co., Ltd., Isesaki-shi (JP)

(72) Inventor: Kentaro FUJII, Isesaki-shi (JP)

(21) Appl. No.: 19/312,984

(22) Filed: Aug. 28, 2025

(30) Foreign Application Priority Data
Sep. 4, 2024 (JP) 2024152420

(51) Int. Cl. F16H 37/12; B60L 53/16; H01R 13/639

(52) U.S. Cl. CPC F16H 37/124; B60L 53/16; H01R 13/639; H01R 2201/26

(57) ABSTRACT

A cam gear 196 of an actuator 10 is configured to transmit a drive force to a locking pin 13. An external lever 17 is provided at the exterior of a housing 11. An internal lever 18 is configured to turn, moving in conjunction with the external lever 17. A cam piece 191 is configured to move in conjunction with the cam gear 196 and is disposed in a position contacting the internal lever 18. The cam piece 191 has a sliding contact surface 192 and a pressed end 193. When the turning of the external lever 17 has started, the internal lever 18 applies pressure while sliding in contact with the sliding contact surface 192 of the cam piece 191, whereby the cam gear 196 turns. After the cam gear 196 has turned more than a certain amount, the cam gear 196 turns further due to the internal lever 18 abutting against and applying pressure to the pressed end 193 of the cam piece 191.

### BACKGROUND OF THE INVENTION

The present invention relates to an actuator.

In order to obtain drive power, electric automobiles and plug-in hybrid automobiles are equipped with large onboard batteries. In order to charge the onboard battery, an external connector, which is connected to an external power source, and a vehicle-side connector, which is provided on the vehicle side, must be connected. Furthermore, a locking mechanism is provided, in order that, in the connected state, the external connector and the vehicle-side connector do not inadvertently separate.

When charging an electric automobile or plug-in hybrid automobile, the vehicle is first parked in the vicinity of a charging facility, and the external connector of the charging facility and the vehicle-side connector are connected. Further, the locking mechanism locks the external connector and the vehicle-side connector. Thereafter, power is supplied from the external power source to the onboard battery to charge the onboard battery.

When charging has ended, after releasing locking by the locking mechanism, the external connector is removed from the vehicle-side connector.

Furthermore, as described in Japanese Patent Laid-Open Publication No. 2014-120392, a locking mechanism has also been developed with which inadvertent release of the locking mechanism can be prevented. Said locking mechanism is constituted by a hook provided at the tip of a charging connector, an engagement protrusion formed at the tip of a power receiving connector, and an actuator provided above the power receiving connector. When the hook is caught in the engagement protrusion, a state is set, in which the charging connector cannot be pulled out of the power receiving connector.

Once the charging connector is attached to the power receiving connector, the locking pin of the actuator advances and the forward part of the locking pin is disposed above the hook of the charging connector. Because tilting of the hook is restricted by the locking pin and the hook is fixed in a state engaged with the engagement protrusion, the charging connector can be prevented from being disengaged from the power receiving connector.

In addition, a lock release lever is provided on the upper surface of the housing upper of the actuator. In the event of an emergency such as a power failure, the user can manually forcibly rotate the cam member and retract the locking pin by rotating the lock release lever.

However, with the locking device described in Japanese Patent Laid-Open Publication No. 2014-120392, there was room for improvement in the drive mechanism of the lock release lever, which is the release operation part.

Specifically, when a turning mechanism (cam member and rotating shaft) is interposed between the aforementioned locking pin and lock release lever, the lock release lever is directly fixed to said turning mechanism, and therefore the turning mechanism and the release lever turn at the same turning angle. Thus, a wide turnable range was desired for the turning mechanism, the turning range of the release lever also had to be wide, and a wide space was needed around the release lever.

In addition, there was a problem in that, when the turning mechanism was turned by a motor in order to advance and retract the locking pin, the release lever would also turn unnecessarily.

### SUMMARY OF THE INVENTION

One or more working examples of the present invention have been made in view of such problems, and an object of one or more working examples of the present invention is to provide an actuator with which the turning range of a release operation part (release lever or the like) required when retracting the locking pin can be narrowed.

An embodiment of the actuator of the present invention comprises: a drive source that generates a drive force; a gear that transmits the drive force to a locking pin; a release operation part provided at the exterior of a housing; an internal lever provided at the interior of the housing and configured to turn, moving in conjunction with the release operation part; and a cam piece configured to move in conjunction with the gear and disposed in a position contacting the internal lever, the cam piece having a sliding contact surface and a pressed end, wherein when turning of the release operation part has started as a result of operating the release operation part, the internal lever applies pressure while sliding in contact with the sliding contact surface of the cam piece, whereby the gear turns, and after the gear has turned more than a certain amount, the gear turns further due to the internal lever abutting against and applying pressure to the pressed end of the cam piece.

In another embodiment of the actuator of the present invention, the internal lever is configured not to move in conjunction with the cam piece when the release operation part is in a start position.

In another embodiment of the actuator of the present invention, the cam piece further comprises a thick part, and the thick part is disposed adjacent to the sliding contact surface and the pressed end.

In another embodiment of the actuator of the present invention, the sliding contact surface is a curved shape that slopes radially outward in the direction of turning as a result of operation of the release operation part.

In another embodiment of the actuator of the present invention, the pressed end presents a shape protruding in the opposite direction to the direction of turning as a result of operation of the release operation part.

With the actuator of the present invention, when the user operates the locking pin by turning the release operation part, the turning angle of the gear can be greater than the turning angle of the release operation part. Thus, the turning range of the release operation part and the internal lever can be reduced, and the space required for the placement and operation of the actuator can be reduced.

### BRIEF DESCRIPTION OF THE DRAWINGS

FIG. 1A is a side view illustrating the disconnected state in an embodiment of the present invention.

FIG. 1B is a side view illustrating the connected state and the unlocked state in an embodiment of the present invention.

FIG. 1C is a side view illustrating the connected state and the locked state in an embodiment of the present invention.

FIG. 2 is a perspective view illustrating an actuator according to an embodiment of the present invention.

FIG. 3A is a view illustrating the actuator according to the embodiment of the present invention, which is a plan view illustrating the state in which the external lever has not been operated.

FIG. 3B is a view illustrating the actuator according to the embodiment of the present invention, which is a plan view illustrating the state in which the external lever has been operated.

FIG. 4A is a view illustrating the actuator according to the embodiment of the present invention, which is a perspective view illustrating the cam piece, the internal lever, and a moving body.

FIG. 4B is a view illustrating the actuator according to the embodiment of the present invention, which is a perspective view illustrating the cam piece, the internal lever, and the moving body, from another angle.

FIG. 5 is a view illustrating the actuator according to the embodiment of the present invention, which is a plan view illustrating the internal lever and the cam member.

FIG. 6 consists of views illustrating the actuator according to the embodiment of the present invention, which are plan views illustrating the turning of the internal lever and the cam member, associated with changes in the amount of protrusion of the locking pin.

FIG. 7A is a view partially illustrating the actuator according to the embodiment of the present invention, which is a plan view illustrating the state in which the external lever has not been operated.

FIG. 7B is a view partially illustrating the actuator according to the embodiment of the present invention, which is a plan view illustrating the state in which the external lever has been operated.

FIG. 8A is a view illustrating the actuator according to a comparative example, which is a plan view illustrating the state in which the external lever has not been operated.

FIG. 8B is a view illustrating an actuator according to a comparative example, which is a plan view illustrating the state in which the external lever has been operated.

### DETAILED DESCRIPTION OF THE PREFERRED EMBODIMENTS

Hereafter, embodiments of the present invention will be described in detail based on the drawings. In the following description, the same members are, in principle, given the same reference numerals, and repeated descriptions are omitted. In the following description, when descriptions are made using the up, down, front, back, left, and right directions, these directions serve for convenience of explanation. Furthermore, left-right is the direction in which the external-side connector 22, which will be described below, is inserted and removed with respect to the vehicle-side connector 21. Furthermore, the left is the vehicle external side, and the right is the vehicle interior side.

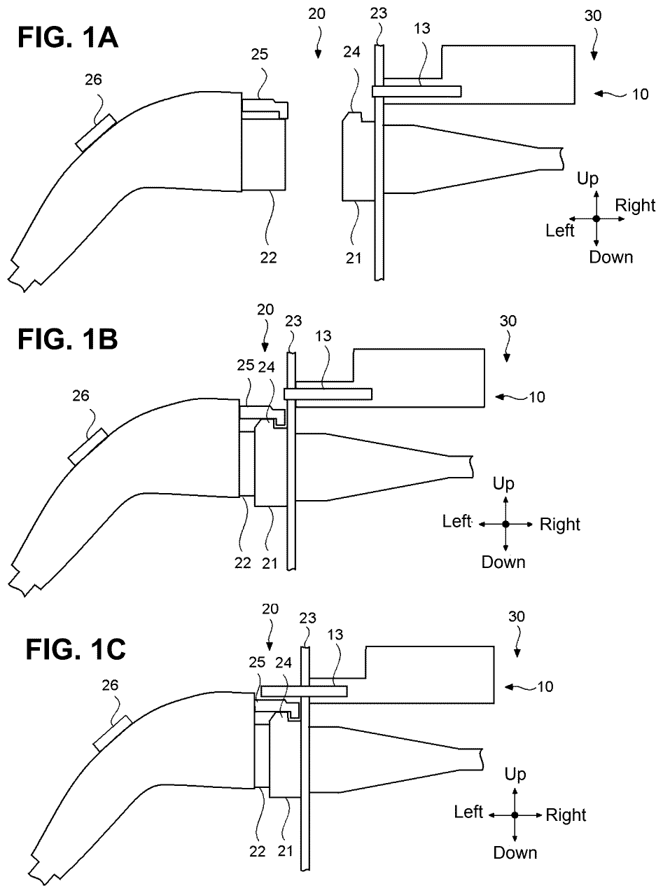

A locking device 20 according to the present embodiment will be described, referring to FIG. 1A to FIG. 1C. FIG. 1A is a side view illustrating the disconnected state. FIG. 1B is a side view illustrating the connected state and the unlocked state. FIG. 1C is a side view illustrating the connected state and the locked state. Here, the connected state is a state in which the vehicle-side connector 21 and the external-side connector 22 are electrically connected. The disconnected state is a state in which the vehicle-side connector 21 and the external-side connector 22 are not electrically connected. The locked state is a state in which the engagement of a vehicle body-side locking part 24 and an external-side engagement part 25, which will be described below, is locked by a locking pin 13.

Referring to FIG. 1A, the locking device 20 is a device that locks the external-side connector 22 and the vehicle-side connector 21. The locking device 20 mainly comprises the external-side engagement part 25, which is disposed on the external-side connector 22, a vehicle body-side locking part 24, which is disposed on the vehicle-side connector 21, and an actuator 10. As will be described below, a locked state results from connecting vehicle-side connector 21 and the external-side connector 22, engaging the external-side engagement part 25 with the vehicle body-side locking part 24, and extending the locking pin 13 of the actuator 10 in the vicinity of the external-side engagement part 25 to prevent the external-side engagement part 25 from disengaging.

The vehicle-side connector 21 is a connector provided on the vehicle body 23 for the purpose charging a battery, which is not shown, installed in the vehicle 30. A vehicle body-side locking part 24 is formed in the vicinity of the upper end of the vehicle-side connector 21. The vehicle body-side locking part 24 is an upwardly protruding protrusion. Furthermore, the lateral surface of the vehicle body-side locking part 24 that faces the external-side engagement part 25 is an inclined surface, which is inclined upward to the right. Here, the vehicle 30 is a vehicle provided with a rechargeable battery for generating a drive force such as, for example, an EV (Electric Vehicle), a PHV (Plug-In Hybrid Vehicle), or the like.

The external-side connector 22 is a connector provided at an end of a cable that extends from a power supply facility installed externally, which is not shown, for the purpose of supplying power to the battery installed in the vehicle 30. The external-side connector 22 has the external-side engagement part 25 and a knob 26.

The external-side engagement part 25 is an engagement part disposed on the upper right end of the external-side connector 22. The external-side engagement part 25 is turnable, with the left end thereof as the turning center. Furthermore, the external-side engagement part 25 is biased in the clockwise direction by a spring or the like, which is not shown.

The knob 26 is provided so as to be capable of being pushed in against the external-side connector 22. The knob 26 and the external-side engagement part 25 are configured so as to be linked. That is to say, while the user is not operating the knob 26, the external-side engagement part 25 is in the reclined state illustrated in FIG. 1A. On the other hand, when the user pushes in the knob 26, the external-side engagement part 25 tilts in counterclockwise turning, which is to say, tilts upward to the right.

The actuator 10 is a device disposed in the vicinity of the vehicle-side connector 21 on the side of the vehicle body 23. As will be described below, the actuator 10 has a locking pin 13. The locking pin 13 can advance and retract in the left-right direction. A locked state that prevents disengagement of the external-side engagement part 25 results from the locking pin 13 extending to the left. On the other hand, an unlocked state that permits disengagement of the external-side engagement part 25 results from the locking pin 13 moving to the right. The actuator 10 uses the drive force of a motor 33 incorporated in the actuator 10, which is described hereafter, to move the locking pin 13 in the left-right direction, based on the instructions of a computational control part, which is a CPU or the like, which is not shown here.

Referring to FIG. 1B, when the user establishes a connected state, in which the external-side connector 22 is inserted into the vehicle-side connector 21, the external-side engagement part 25 engages the vehicle body-side locking part 24. As mentioned above, the left lateral surface of the vehicle body-side locking part 24 is an inclined lateral surface. Furthermore, the external-side engagement part 25 is biased in the clockwise direction. Thus, when the external-side connector 22 is inserted into the vehicle-side connector 21, after tilting along the inclined lateral surface of the vehicle body-side locking part 24, the external-side engagement part 25 engages the vehicle body-side locking part 24.

Referring to FIG. 1C, after the external-side engagement part 25 engages the vehicle body-side locking part 24, the locking pin 13 moves to the left, based on a user operation or a computational control part instruction. The locking device 20 is thereby in the locked state. In the locked state, the left-side part of the locking pin 13 is disposed in the vicinity of on the upper side of the external-side engagement part 25. Thus, even if the user pushes the knob 26 in an accidental operation and, as a result, the external-side engagement part 25 attempts to turn counterclockwise and lift the tip of the external-side engagement part 25, because the locking pin 13 presses onto the external-side engagement part 25, there will be substantially no lifting of the external-side engagement part 25. Thus, the engaged state between the vehicle body-side locking part 24 and the external-side engagement part 25 is maintained, even if such an accidental operation occurs. Therefore, the locked state of the locking device 20 can be prevented from being inadvertently released. Accordingly, inadvertent separation of the external-side connector 22 and the vehicle-side connector 21 while charging the rechargeable battery that is installed in the vehicle 30, can be prevented.

In such a locked state, charging of the onboard battery installed in the vehicle 30 is performed. After this charging has ended, the locking pin 13 moves to the right, based on a user operation or a computational control part instruction. This places the locking device 20 in the unlocked state illustrated in FIG. 1B. In this state, when the user pushes in the knob 26, the external-side engagement part 25 turns counterclockwise, thereby releasing the engagement of the external-side engagement part 25 and the vehicle body-side locking part 24. Furthermore, the connection between the vehicle-side connector 21 and the external-side connector 22 is released by the user pulling the external-side connector 22 to the left. The vehicle 30 is thereby in a drivable state.

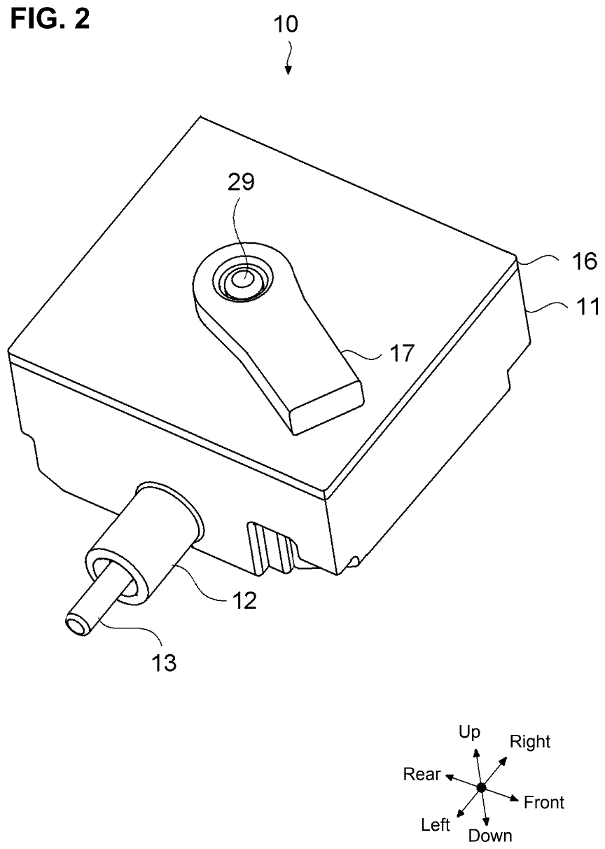

FIG. 2 is a perspective view illustrating the actuator 10.

The actuator 10 mainly comprises a housing 11, a protruding hole 12, and the locking pin 13. The actuator 10 can be placed in the locked state and the unlocked state, as mentioned above.

The housing 11 is the body of the actuator 10 and presents a container-like shape with an open top. The top opening of the housing 11 is covered by a lid member 16. A drive mechanism, which is described hereafter, is disposed at the interior of the housing 11 for the purpose of moving the locking pin 13. A synthetic resin including glass fibers is, for example, employed as the material for the housing 11.

The protruding hole 12 is a cylindrical portion protruding toward the exterior from the housing 11. The protruding hole 12 is a member that is integrally continuous with the housing 11. The protruding hole 12 and the housing 11 are formed, for example, by injection molding. The protruding hole 12 presents an approximately cylindrical shape, for example. The interior of the protruding hole 12 communicates with the interior of the housing 11.

A locking pin 13 is an approximately cylindrical portion disposed so as to be able to advance toward, and retract from, the exterior, by way of the protruding hole 12. A highly rigid metal, such as SUS, for example, is employed as the material for the locking pin 13.

The external lever 17 is a release operation part configured to be operated by a user in an emergency such as a power failure. The external lever 17 can turn clockwise and counterclockwise, with a shaft part 29, which is described hereafter, as the turning center. As will be described hereafter, the amount of protrusion of the locking pin 13 can be changed by the user operating the external lever 17. Here, other turnable members such as knobs can also be employed, as the release operation part.

In an emergency such as a power failure, the user turns the external lever 17 counterclockwise. In this way, the locking pin 13 is retracted and the amount of protrusion is shortened. The actuator 10 is thereby set to the unlocked state illustrated in FIG. 1B from the locked state illustrated in FIG. 1C, and the user can establish the disconnected state by pulling out the external-side connector 22.

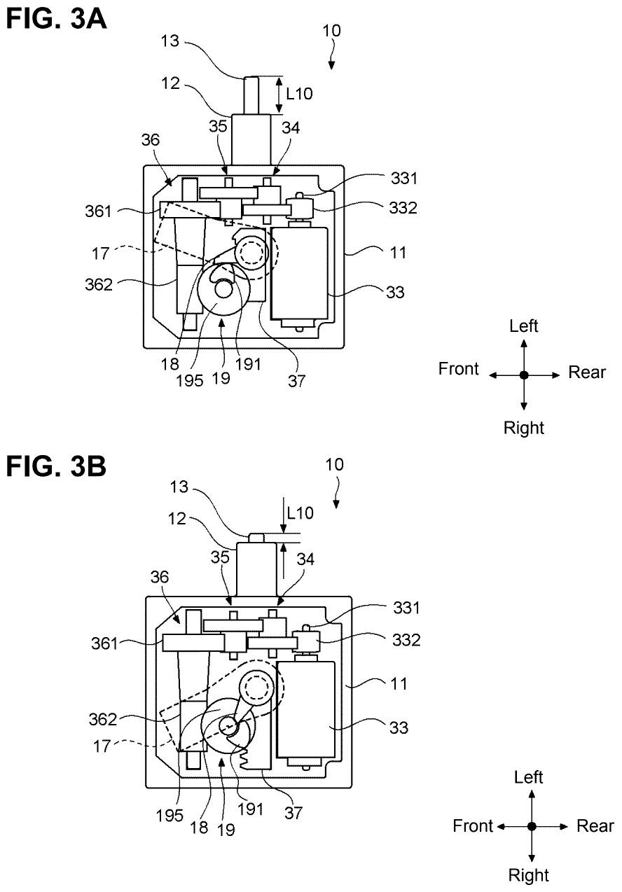

FIG. 3A is a plan view illustrating the actuator 10 in the locked state and the state in which the external lever 17 has not been operated by turning. FIG. 3B is a plan view illustrating the actuator 10 in the state in which the external lever 17 has been operated by turning and manually set to the unlocked state. For descriptive expediency, FIG. 3A and FIG. 3B do not show the aforementioned lid member 16. Here, the state in which the external lever 17 has not been operated by turning is a state in which the aforementioned locking device 20 is being electrically operated without problems. Furthermore, the state in which the external lever 17 has been operated by turning is a state in which the aforementioned locking device 20 is unlocked by manually retracting the locking pin 13 when some problem such as a power failure has occurred.

Referring to FIG. 3A, the actuator 10 comprises a drive mechanism at the interior of the housing 11 for changing the amount of protrusion L10 of the locking pin 13. This drive mechanism includes a motor 33, which is drive source, turning bodies such as a first turning body 34, a cam member 19, a moving body 37, and the like. Here, each turning body, such as the first turning body 34, as well as the cam member 19, the moving body 37, and the like, are components made from injection-molded synthetic resin, metal, or the like. Note that, in order to simplify the drawings, illustration of the gear teeth formed on each turning body, such as the first turning body 34, and the gear teeth formed on the cam body part 195, which is described hereafter, is omitted. Such matters are the same in the following drawings.

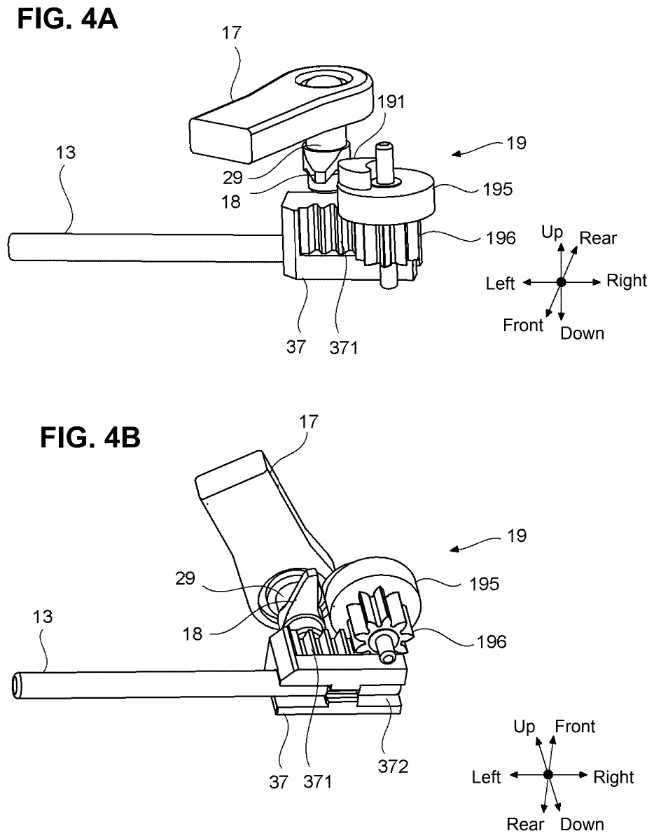

The actuator 10 mainly comprises a cam gear 196 (illustrated in FIG. 4A, and the like), which is a gear, the external lever 17, the internal lever 18, and a cam piece 191. When a problem such as a power failure occurs, the actuator 10 allows the locking pin 13 to be retracted, transitioning the locking device 20 to the unlocked state, by way of the user manually operating the external lever 17 by turning.

The cam gear 196 is a gear that transmits a drive force to the locking pin 13. Since the cam gear 196 is a part that constitutes the lower portion of the cam member 19, the cam gear 196 does not appear in FIG. 3A and FIG. 3B. The cam gear 196 is described hereafter, referring to FIG. 4A and the like.

The external lever 17 is a manual lever provided at the exterior of the housing 11. The details of the external lever 17 are as described above, referring to FIG. 2. In FIG. 3A and FIG. 3B, the external lever 17 is illustrated as transparent, in order to clearly illustrate the internal configuration of the housing 11.

The internal lever 18 is a portion that is configured to turn, moving in conjunction with the external lever 17. The details of the internal lever 18 will be described hereafter, referring to FIG. 4A and the like.

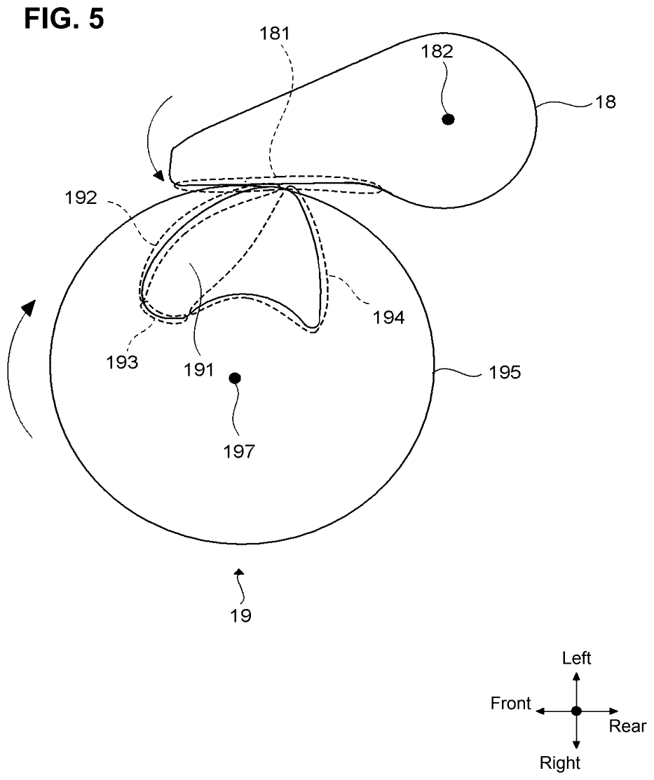

The cam piece 191 is configured to move in conjunction with the cam gear 196, which is described hereafter, and is disposed in a position contacting the internal lever 18. The cam piece 191 is described hereafter referring to FIG. 5.

At the interior of the housing 11, there is the motor 33, serving as a drive source that generates a drive force for the purpose of changing the amount of protrusion of the locking pin 13, a first turning body 34, a second turning body 35, a third turning body 36, the cam member 19, and the moving body 37. All of these devices and the like are housed in a concave region formed at the interior of the housing 11.

The motor 33 is housed at the rear end at the interior of the housing 11. A drive gear 332 is connected to the turning shaft 331 of the motor 33, in a relatively non-turnable manner.

At the interior of the housing 11, the first turning body 34, the second turning body 35, and the third turning body 36 are disposed, in order to transmit the turning power generated by the motor 33 to the cam member 19. The first turning body 34, the second turning body 35, and the third turning body 36 have parallel turning axes, in the left-right direction.

The first turning body 34 and the second turning body 35 are two-level gears that combine two levels of spur gears, which have a large diameter and a small diameter, and transmit the turning power generated by the motor 33 while decelerating.

The third turning body 36 has a spur gear part 361 and a worm part 362. The spur gear part 361 meshes with the second turning body 35. The worm part 362 meshes with the cam body part 195 of the cam member 19, which is described hereafter. Turning shafts formed at the left end and right end of the first turning body 34, the second turning body 35, and the third turning body 36 are turnably supported by recessed portions formed at the interior of the housing 11.

The cam member 19 is a turning body having a cam piece 191, which is described hereafter, and has a turning axis in the vertical direction. The cam member 19 has the cam gear 196, which does not appear in the drawings here. The non-illustrated cam gear 196, meshes with a rack gear 371 formed on the moving body 37, which is described hereafter. The cam member 19 has the cam piece 191. The configuration and the like of the cam piece 191 will be described hereafter, referring to FIG. 5.

The internal lever 18 is a lever configured to turn together with the external lever 17. The internal lever 18 is disposed at the interior of the housing 11. The details of the internal lever 18 will be described hereafter referring to FIG. 4A and the like.

The moving body 37 is a member that is attached to the locking pin 13 and moves linearly in the left-right direction together with the locking pin 13. The details of the moving body 37 will be described hereafter referring to FIG. 4A and the like.

The configuration is such that, in the locked state illustrated in FIG. 3A, which is to say, when the external lever 17 is in the starting position, the internal lever 18 does not move in conjunction with the cam piece 191. Thus, even though the cam piece 191 is turned together with the cam gear 196, which is described hereafter, when the locking pin 13 is displaced by the drive force of the motor 33, the cam piece 191 does not act on the internal lever 18 in any way. Thus, it is possible to prevent the external lever 17 from turning unnecessarily when the locking pin 13 is extended and retracted by electric power.

Here, the operation of the actuator 10 by electric power will be described. First, the method of setting the actuator 10 to the locked state, from the unlocked state, will be described. Specifically, the motor 33 causes the drive gear 332 to turn based on an instruction or the like from the control means, which has detected the connection state illustrated in FIG. 1B or the like. Thereupon, the turning power of the drive gear 332 is transmitted in the order of the first turning body 34, the second turning body 35, the third turning body 36, the cam member 19, which is described hereafter, the cam gear 196, which is described hereafter, and the rack gear 371, which is described hereafter, and the locking pin 13 is moved to the left. This sets the actuator 10 in the locked state illustrated in FIG. 1C.

Conversely, when the actuator 10 is set to the unlocked state, from the locked state, the control means causes the motor 33 to turn in the reverse direction. Thereupon, turning power is transmitted by way of the same transmission path as when the locked state is set, and the locking pin 13 moves to the right. This sets the actuator 10 in the unlocked state illustrated in FIG. 1B.

In the locked state illustrated in FIG. 3A, when the external lever 17 turns counterclockwise due to manual operation by the user in an emergency, the internal lever 18 also turns counterclockwise at the same time.

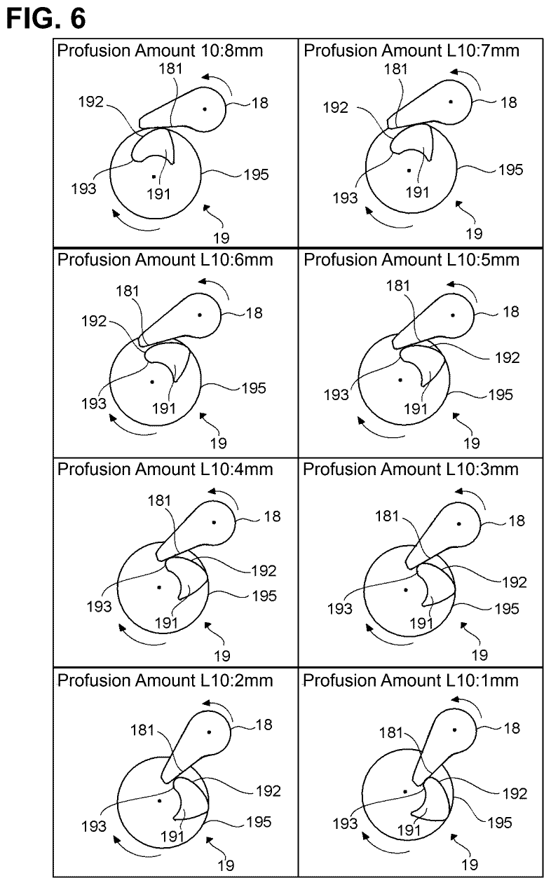

Referring to FIG. 3B, as a result, the internal lever 18 applies a counterclockwise pressing force on the cam piece 191. Thereupon, the cam member 19, including the cam piece 191, turns clockwise. As will be described hereafter, the turning angle of the cam member 19 is much greater than the turning angle of the external lever 17 and the internal lever 18. The cam gear 196 on the cam member 19, which is described hereafter, meshes with the rack gear 371 on the moving body 37, which is described hereafter. Thus, in accordance with the turning of the cam member 19, the moving body 37 moves towards the right. Since the locking pin 13 moves towards the right in accordance with the movement of the moving body 37, the amount of protrusion L10 of the locking pin 13 decreases. This sets the locking pin 13 in the unlocked state illustrated in FIG. 1B. Such operations will be described hereafter referring to FIG. 6 and the like.

Referring to FIG. 3B, after being manually set in the unlocked state, the function of the actuator is restored, and when transitioning to the locked state by way of electric power, the overall cam member 19, including the cam piece 191, turns counterclockwise. At this time, the cam piece 191 applies a counterclockwise pressing force to the internal lever 18. The internal lever 18 and the external lever 17 then turn clockwise and the external lever 17 returns to the starting position, reverting to the state illustrated in FIG. 3A. After this state has been set, even if the cam member 19 turns clockwise and counterclockwise by way of electric power, the cam piece 191 does not act on the internal lever 18 in any way. Thus, when in the state of FIG. 3A, the internal lever 18 does not move in conjunction with the cam piece 191 and the external lever 17 can be prevented from turning unnecessarily.

FIG. 4A is a perspective view illustrating the cam piece 191, the internal lever 18, and the moving body 37. FIG. 4B is a perspective view illustrating the cam piece 191, the internal lever 18, and the moving body 37, from another angle.

Referring to FIG. 4A, the external lever 17 and the internal lever 18 are assembled in a relatively non-turnable manner with respect to the generally cylindrical shaft part 29. The internal lever 18 is disposed at the interior of the housing 11 and is disposed at the same position as the cam piece 191 in the vertical direction.

Referring to FIG. 4A and FIG. 4B, the moving body 37 is a member presenting a generally rectangular parallelepiped shape. A rack gear 371 is formed on the front surface of the moving body 37. The rack gear 371 is a straight toothed gear that meshes with the cam gear 196 on the cam member 19, which is described hereafter. The moving body 37 is recessed from the bottom surface to form a concave part 372. The concave part 372 is formed from the left end to the right end of the moving body 37. The right end portion of the locking pin 13 is received in the concave part 372. A reduced diameter portion is formed in the vicinity of the right end of the locking pin 13. A narrow portion is formed in an intermediate portion of the concave part 372. The reduced diameter portion of the locking pin 13 fits into the narrow portion of the concave part 372. This fixes the relative position of the locking pin 13 and the moving body 37 in the left-right direction, such that the locking pin 13 and the moving body 37 move together in the left-right direction.

The cam member 19 has the cam body part 195, the cam gear 196, and the cam piece 191. Furthermore, the cam member 19 has turning shafts at the upper and lower ends. These turning shafts are disposed so as to be turnable in the aforementioned housing 11.

The cam body part 195 is a portion presenting a disc-shape. This is a worm wheel, in which oblique teeth are formed on the lateral surface of the disk shape, which mesh with a worm part 362 illustrated in FIG. 3A.

The cam gear 196 is a spur gear disposed on the bottom surface of the cam body part 195. The cam gear 196 meshes with the rack gear 371 on the moving body 37.

The cam piece 191 is a protruding part where the upper surface of the cam body part 195 protrudes upward locally. The cam piece 191 is a portion that is pressed by the internal lever 18 when the user turns the external lever 17. As will be described hereafter, the cam member 19 turns in the circumferential direction, due to the internal lever 18 pressing the cam piece 191. The shape of the cam piece 191 will be described in detail hereafter, referring to FIG. 5.

FIG. 5 is a top view illustrating the internal lever 18 and the cam member 19. Here, the position when the user has not operated the external lever 17, which is not shown, which is to say the position in which turning of the internal lever 18 starts, is illustrated.

The internal lever 18 is turnable with the lever turning center 182 as the turning center. Specifically, when the user turns the aforementioned external lever 17 counterclockwise, the internal lever 18 also turns counterclockwise at the same time. As illustrated in FIG. 4A and the like, the external lever 17 and the internal lever 18 are both connected to the shaft part 29 in a relatively non-turnable manner. Thus, the turning angle at which the internal lever 18 turns and the turning angle at which the external lever 17 turns, as a result of operation by the user, are the same.

The internal lever 18 has a lever sliding contact surface 181 on the front right lateral surface. The lever sliding contact surface 181 is a lateral surface that contacts the cam piece 191 when the internal lever 18 turns counterclockwise about the lever turning center 182.

When the aforementioned external lever 17 is operated by the user, the internal lever 18 turns counterclockwise with the lever turning center 182 as the turning center. Meanwhile, the cam member 19 turns clockwise with the cam turning center 197 as the turning center.

The cam piece 191, as previously described, is a portion where the upper surface of the cam body 195 protrudes upward locally. The cam piece 191 is disposed at the peripheral edge of the cam body part 195. The cam piece 191 has a lateral surface at a distance from the cam turning center 197 that is not constant. Specifically, the cam piece 191 has the sliding contact surface 192, a pressed end 193, and a thick part 194. In FIG. 5, each of the portions constituting the cam piece 191 is surrounded by a dotted line.

The sliding contact surface 192 is a curved shape that slopes radially outward in the direction in which the cam member 19 turns as a result of the operation of the external lever 17. The sliding contact surface 192 is a lateral surface of the cam piece 191 extending from the radially outward end of the cam piece 191 to the vicinity of the end of the cam piece 191 on the counterclockwise side. As will be described hereafter, having the sliding contact surface 192 makes it possible to increase the turning angle of the cam member 19 relative to the turning angle of the internal lever 18.

The pressed end 193 presents a shape that protrudes in the opposite direction to the direction in which the cam member 19 turns as a result of the operation of the external lever 17. The pressed end 193 is the end of the cam piece 191 on the counterclockwise side and is smoothly continuous with the end of the sliding contact surface 192 on the counterclockwise side. As will be described hereafter, having the pressed end 193 allows the internal lever 18 to push in the pressed end 193 and thereby increase the turning angle of the cam member 19 relative to the turning angle of the internal lever 18.

The thick part 194 is a portion that is provided adjacent to the sliding contact surface 192 and the pressed end 193, in the circumferential direction. Specifically, the thick part 194 is a portion further to the clockwise side of the clockwise ends of the sliding contact surface 192 and the pressed end 193 of the cam piece 191. With such a configuration, the cam piece 191 can be reinforced by the thick part 194, and the cam piece 191 can be prevented from deforming or the like when the internal lever 18 presses the cam piece 191.

FIG. 6 consists of top views illustrating the turning of the internal lever 18 and the cam member 19 associated with the aforementioned change in the amount of protrusion L10 of the locking pin 13. Here, the states of the internal lever 18 and the cam member 19 are illustrated when the amount of protrusion L10 of the locking pin 13 is decreased from 8 mm to 1 mm in 1 mm increments, as illustrated in FIG. 3A and the like.

When the amount of protrusion L10 is 8 mm, counterclockwise turning of the external lever 17 is started as a result of manual operation by the user, and the lever sliding contact surface 181 of the internal lever 18 applies pressure while sliding in contact with the sliding contact surface 192 of the cam piece 191. The direction in which the lever sliding contact surface 181 applies pressure against the sliding contact surface 192 is the counterclockwise direction. This causes the cam member 19 and the cam gear 196, which is not shown, which is disposed on the cam member 19, to turn in the clockwise direction. Then, referring to FIG. 4A, as a result of the meshing of the cam gear 196 and the rack gear 371, the moving body 37 and the locking pin 13 move to the right. As a result, referring to FIG. 3A, the amount of protrusion L10 of the locking pin 13 is shortened.

When the user further turns the external lever 17 counterclockwise, the lever sliding contact surface 181 of the internal lever 18 further applies pressure while sliding in contact with the sliding contact surface 192 of the cam piece 191. As a result, the amount of protrusion L10 gradually shortens to 7 mm, 6 mm, and 5 mm.

When the amount of protrusion L10 shortens to 4 mm, which is to say, after the cam gear 196 has turned at least a certain amount, the lever sliding contact surface 181 of the internal lever 18 abuts against and applies pressure to the pressed end 193 of the cam piece 191. The lever sliding contact surface 181 presses the pressed end 193, which is the end of the cam piece 191, in the counterclockwise direction. This causes the aforementioned cam gear 196 to turn further clockwise.

When the user further turns the external lever 17 counterclockwise, the lever sliding contact surface 181 of the internal lever 18 further applies counterclockwise pressure while pressing the pressed end 193 of the cam piece 191. As a result, the cam gear 196, which is not shown, further rotates clockwise, and the amount of protrusion L10 gradually shortens to 3 mm, 2 mm, and 1 mm.

When the amount of protrusion L10 shortens to 1 mm, the actuator 10 is set to the unlocked state illustrated in FIG. 1B. Thus, the user can release the engagement of the vehicle-side engagement part 25 and the vehicle body-side locking part 24 by pushing in the knob 26, and remove the external-side connector 22 from the vehicle-side connector 21.

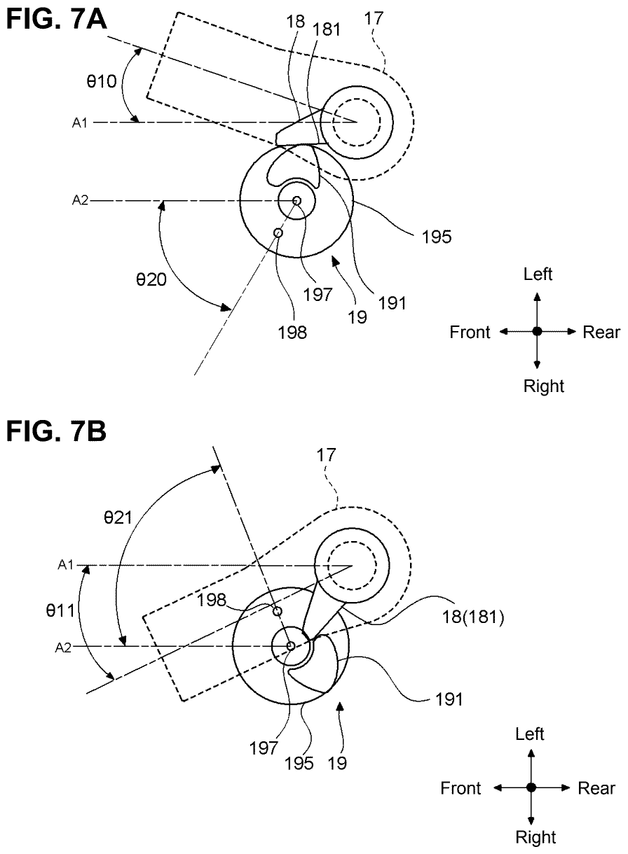

FIG. 7A is a plan view of the actuator 10 according to the present embodiment, illustrating the locked state and the state in which the external lever 17 has not been operated. FIG. 7B is a plan view illustrating the state in which, in the actuator 10 according to the present embodiment, the external lever 17 has been manually operated and the unlocked state has been set. In FIG. 7A and FIG. 7B, from among the components that constitute the actuator 10, only the external lever 17, the internal lever 18, the cam member 19, and the like have been selected for illustration.

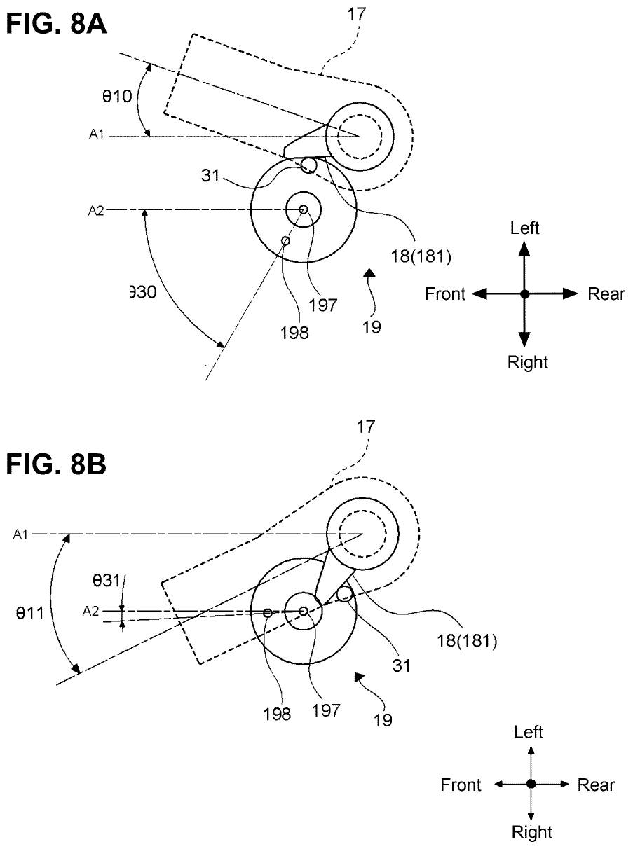

In FIG. 7A and FIG. 7B, a first reference axis A1 is defined, which passes through the turning center of the external lever 17 (which is the same as the lever turning center 182 of the internal lever 18) and is parallel to the front-rear direction. Further, a second reference axis A2 that passes through the cam turning center 197 of the cam member 19 and is parallel to the front-rear direction is defined. Such matters are also the same in FIG. 8A and FIG. 8B.

Referring to FIG. 7A, in the state in which the external lever 17 has not been operated, the angle θ10 at which the external lever 17 is inclined clockwise from the first reference axis A1 is 19°. Also, in such a state, the angle θ20 at which the line segment connecting the cam turning center 197 of the cam member 19 and a check part 198 represented for convenience is inclined toward the counterclockwise direction from the second reference axis A2 is 60°.

Referring to FIG. 7B, in a state in which the external lever 17 has been operated, the angle θ11 at which the external lever 17 inclines counterclockwise from the first reference axis A1 is 26°. Furthermore, in such a state, the angle θ21 at which the line segment connecting the cam turning center 197 of the cam member 19 and the check part 198 is inclined in the clockwise direction from the second reference axis A2 is 69°.

On the basis of the foregoing, the turning angle of the external lever 17 when the locking pin 13 is retracted is 19°+26° ˜ 45°. Meanwhile, when the locking pin 13 is retracted, the turning angle of the check part 198, which is to say, the turning angle of the cam gear 196 of the cam member 19, is 60°+69° ˜ 129°. Thus, the turning angle of the cam gear 196 of the cam member 19 is more than twice the turning angle of the external lever 17. Accordingly, when the user operates the locking pin 13 by turning the external lever 17, the turning angle of the cam gear 196 can be more than twice the turning angle of the external lever 17. Therefore, the turning range of the external lever 17 and the internal lever 18 can be reduced, and the space required for the placement and operation of the actuator 10 can be reduced.

A comparative example will be described referring to FIG. 8A and FIG. 8B. FIG. 8A is a view illustrating the actuator 10 according to the comparative example, which is a plan view illustrating a locked state and a state in which the external lever 17 has not been operated. FIG. 8B is a view illustrating the actuator 10 according to the comparative example, which is a plan view illustrating the state in which the external lever 17 has been manually operated and the unlocked state has been set.

In the actuator 10 illustrated in FIG. 7A and the like, the cam piece 191 was formed on the upper surface of the cam body part 195. On the other hand, in the comparative example illustrated in FIG. 8A and FIG. 8B, a protrusion 31 is formed on the upper surface of the cam body part 195. The protrusion 31 is a portion where the upper surface of the cam body part 195 protrudes in a generally cylindrical shape. Furthermore, a check part 198 is represented on the upper surface of the cam body part 195 for convenience in order to check the turning angle of the cam member 19, similar to that of FIG. 7A and the like.

Referring to FIG. 8A, when the user turns the external lever 17 counterclockwise, the internal lever 18 also turns counterclockwise at the same time, and presses the protrusion 31. This causes the cam member 19 to turn in the clockwise direction. Thus, the cam gear 196, which is not shown here, also turns in the clockwise direction.

Referring to FIG. 8B, when the user turns the external lever 17 further counterclockwise, the internal lever 18 further presses the protrusion 31 and the cam member 19 further turns in the clockwise direction. In accordance with the turning of the cam member 19, the cam gear 196 also turns in the clockwise direction.

Referring to FIG. 8A and FIG. 8B, the angle θ10+θ11 at which the external lever 17 turns counterclockwise is 45°, similar to the actuator 10 illustrated in FIG. 7A and the like.

In FIG. 8A, which illustrates the external lever 17 before turning, the angle 030 at which the line segment connecting the cam turning center 197 and the check part 198 on the cam member 19 is inclined from the second reference axis A2 in the counterclockwise direction is 60°. On the other hand, in FIG. 8B, which illustrates the external lever 17 after turning, the angle θ31 at which the line segment connecting the cam turning center 197 and the check part 198 on the cam member 19 is inclined from the second reference axis A2 in the counterclockwise direction is 3°. Thus, the angle at which the external lever 17 turns is 60°-3°=57°.

Thus, in the comparative example having the protrusion 31 as an alternative to the cam piece 191, the turning angle of the external lever 17 is approximately equivalent to the turning angle of the cam member 19. Therefore, in order to increase the turning angle of the cam member 19, it is necessary to increase the turning angle of the external lever 17 and the internal lever 18. Accordingly, greater space is required for the turning of the external lever 17 and the internal lever 18, making it difficult to reduce the size of the overall actuator 10.

Although embodiments of the present invention have been described above, the present invention is not limited thereto and can be modified without departing from the gist of the present invention. Furthermore, the embodiments described above can be combined with each other.

For example, in the embodiment described above, the cam body part was a worm wheel, on which oblique teeth were formed, but there is no limitation thereto, and this may be a spur gear. The gear configuration of the drive mechanism is in no way limited as long as it has a cam piece that moves in conjunction with a gear that drives the locking pin.

In addition, although the embodiment above describes a case where the actuator of the present invention is applied to a locking device that locks the connection between an external-side-connector and a vehicle-side connector, the actuator of the present invention can also be applied to other locking devices such as for vehicles and for homes.

What is claimed is:

1. An actuator, comprising:
a drive source that generates a drive force;
a gear that transmits the drive force to a locking pin;
a release operation part provided at the exterior of a housing;
an internal lever provided at the interior of the housing and configured to turn, moving in conjunction with the release operation part; and
a cam piece configured to move in conjunction with the gear and disposed in a position contacting the internal lever,
the cam piece having a sliding contact surface and a pressed end, wherein
when turning of the release operation part has started as a result of operating the release operation part, the internal lever applies pressure while sliding in contact with the sliding contact surface of the cam piece, whereby the gear turns,
and after the gear has turned more than a certain amount, the gear turns further due to the internal lever abutting against and applying pressure to the pressed end of the cam piece.

2. The actuator according to claim 1,
wherein, the internal lever is configured not to move in conjunction with the cam piece when the release operation part is in a start position.

3. The actuator according to claim 1,
wherein the cam piece further comprises a thick part,
and the thick part is disposed adjacent to the sliding contact surface and the pressed end.

4. The actuator according to claim 1,
wherein the sliding contact surface is a curved shape that slopes radially outward in the direction of turning as a result of operation of the release operation part.

5. The actuator according to claim 1,
wherein the pressed end presents a shape protruding in the opposite direction to the direction of tuming as a result of operation of the release operation part.
